(19) United States
(12) Patent Application Publication
(10) Pub. No.: US 2006/0245416 A1
(43) Pub. Date: Nov. 2, 2006

(54) Architecture for the separation of call control from media processing

(76) Inventors: Kenneth T. Faubel, Dunstable, MA (US); Jonathan P. Steer, Nashua, NH (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/117,991

(22) Filed: Apr. 29, 2005

(51) Int. Cl. H04L 12/66; H04L 12/56

(52) U.S. Cl. 370/352; 370/401

(57) ABSTRACT

Disclosed is a method of establishing a media call wherein a data stream contains a call control channel and one or more media channels. A network connection between a call control entity and a far end device is established wherein the connection conveys the call control channel. This connection typically utilizes a control protocol such as SIP or H.323. A network connection is established between the call control entity and a media entity, typically using an XML protocol. This connection between the call control entity and the media entity is used to prepare and direct the media entity to receive incoming media. The call control device directs the far end device to establish a media channel network connection between the far end device and the media entity, typically using RTP. By separating the call control channel from the media channel(s), a non-media device, such as an IP telephone can be integrated into a media conferencing experience. This allows the user's station to appear as a single telephony device with a single address and a single point of administration.

### BACKGROUND OF THE INVENTION

1. Field of the Invention

The invention relates to multimedia communications via a network. More specifically, the invention relates to a method of unbinding call control from device control policy and media services. One embodiment of the invention is particularly suited for videoconferencing.

2. Description of the Related Art

As Voice over IP (VOIP) telephones become increasingly common, there is an increased interest in running video on those networks. This may require two different devices, for example, an IP phone and a videoconferencing endpoint. One can attempt to place a video only call between users already in a voice call, but this requires two complete call control devices with separate addresses, administration control, sever infrastructures, etc.

U.S. Pat. No. 6,750,896, by McClure, describes a system wherein video calls between video devices are controlled by presenting video call options and receiving inputs of video call information through a telephone network. A video call application associated with a phone server receives video call information and provides the information to a video launch application that controls video devices accordingly. In one embodiment, IP telephones provide video call options such as initiating and terminating video calls through an IP telephone server to a video network platform using XML formatted data. The video network platform provides video call options based on user code information to simplify the IP telephone interface. The video network platform performs the functions represented by the video call information to establish and terminate video calls as appropriate.

### BRIEF SUMMARY OF THE INVENTION

One aspect of an embodiment of the invention is method of establishing a media call wherein a data stream contains a call control channel and one or more media channels. A network connection between a call control entity and a far end device is established wherein the connection conveys the call control channel. This connection typically utilizes a control protocol such as SIP or H.323, which are know to those skilled in the art. A network connection is established between the call control entity and a media entity, typically using an XML protocol. This connection between the call control entity and the media entity is used to prepare and direct the media entity to receive incoming media. The call control device directs the far end device to establish a media channel network connection between the far end device and the media entity, typically using RTP. By separating the call control channel from the media channel(s), a non-media device, such as an IP telephone can be integrated into a media conferencing experience. This allows the user's station to appear as a single destination device with a single address and a single point of administration.

### BRIEF DESCRIPTION OF THE SEVERAL VIEWS OF THE DRAWINGS

FIG. 1 illustrates a sequence of events for establishing a media call using the disclosed method.

FIG. 2 illustrates an embodiment wherein the call control entity is a softphone application and the media entity is an executable from a video conferencing application.

FIG. 3 illustrates an embodiment wherein the call control entity is an IP phone and the media entity is a teleconferencing CODEC.

### DETAILED DESCRIPTION OF THE INVENTION

The following definitions and abbreviations are used in the disclosure:

Associations—The binding between peer binding companions.

Media entity—An element of a decomposed videoconferencing system that may aggregate any of the several types of devices and services supported by the present invention. A media entity typically generates and/or decodes a RTP stream.

Call Control Entity—The entity responsible for managing various call setup parameters at an end of a multimedia call, typically using standard call control protocols such as H.323 or SIP. The call control entity can be any network based device such as PC based client, a stand alone appliance phone, PDA, or cell phone. The Call Control entity may be viewed as a network proxy or bridge for communicating information from a far end to the devices within the setup association Control Point. The call control entity is also typically used to query the capabilities of associated media entities, select an appropriate media entity for a given media call, and control the media entity.

Logging Entity—The entity responsible for handling synchronization of logging from various media entities.

Event Management—Media entities may generate asynchronous events. The protocol disclosed herein provides event management, i.e., it allows devices to register for and receive events.

Network Application Message Framing—Every message must be “framed” so that the receiver of the message can do first pass validity checking on the message. The lowest layer of the present protocol has a framing mechanism that permits simultaneous and independent exchanges of messages between peers and quick parsing of the message.

Reply Codes—Reply codes are messages with specific information regarding a previous command.

Session—The time from the underlying transport protocol connection to disconnection. In TCP, from connection to BYE.

TLS—Transport Layer Security.

ALG—Application Level Gateway.

SCTP—Stream Control Transmission Protocol (IETF RFC 2960).

SIP—Session Initiation Protocol.

The present disclosure provides a way to add video thereby extending the audio-only capability of a call control entity such as a voice phone. This allows the user's station to appear as a single device with a single address and a single point of administration. This allows a media entity to act essentially as a peripheral to a call control entity such as a standard VoIP device.

According to the teaching herein, call control is unbound from device control policy and media services. Also disclosed is an application layer device control protocol that allows reliable exchanges of control messages, media stream descriptions, configuration and state information between peer call control entities and media entities.

The call control entity and a media entity can communicate over a network connection. The media entity, for example a video codec (coder/decoder), can be implemented as a computer application, or as one of an array of DSP accelerated devices such as an integrated DSP and flat panel display, a snap-on panel for the back of an IP phone, or a traditional set-top or rack mount CODEC. The call control entity and media entity communicate using a protocol, as describe below. Decomposing a traditional videoconferencing device into separate media devices allows devices that are uniquely and historically suited for their various purposes, such as an audio telephone, to be integrated into the videoconferencing experience.

The systems described herein uses a connection-oriented control protocol that allows a peer connection between two media devices to exchange device and media control commands and responses using textual XML messages. Layered on top of the control protocol are media entity services for controlling various aspects of the media. The protocol supports standard device control semantics and media control semantics that can be signaled between the near-end call control entity and far-end call control entity. These semantics include, for example, media stream starting, stopping, pausing, refreshing, muting; camera control; and security and encryption. The protocol also supports semantics that allow synchronization between various media devices for services such as logging and provisioning.

Examples of media services are, for example, live video feed such as in video conference, content video such as a video presentation, audio media, camera control, logging, provisioning, etc. Systems embodying the teachings herein can aggregate several services within a single device, for example, call control and logging in a single device, and audio capture and audio encoding in a single device. However, a media entity need not have all of the afore-mentioned services.

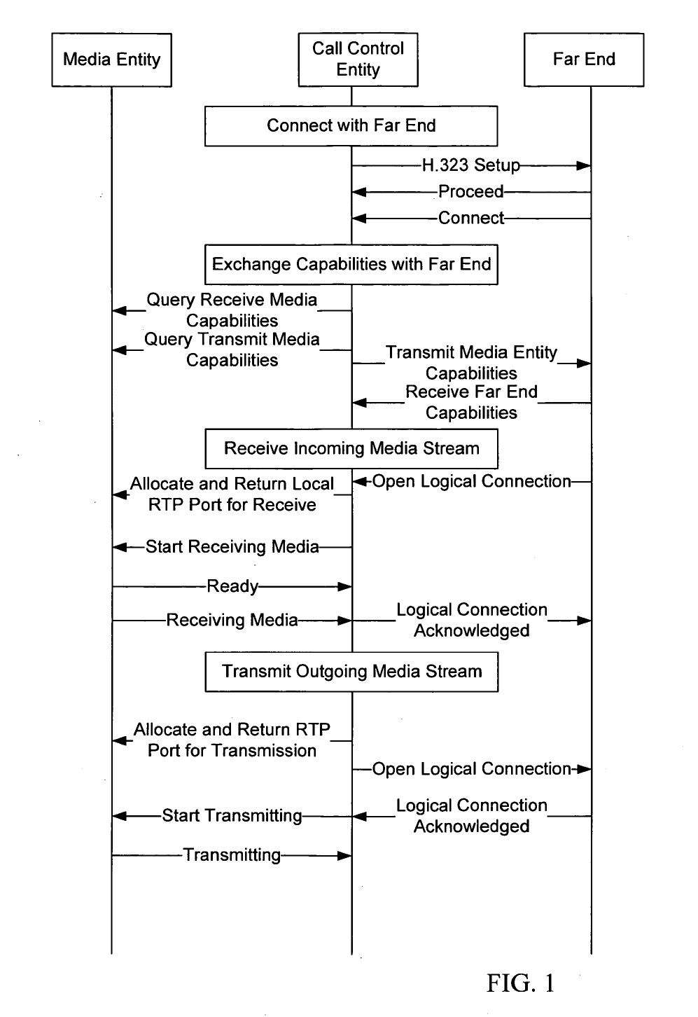

An example of a media exchange embodying aspects of the present disclosure is illustrated in FIG. 1. A user desires to set up a media call with a far end. The user uses a call control entity, such as an IP telephone to establish a connection with the far end. Call control is achieved using a call control protocol such as H.323 or SIP. The user's call control entity establishes a connection with a media entity, such as a video conferencing codec. The media entity's receiving and transmitting capabilities are determined and also the transmitting and receiving capabilities of the far end are determined. When the user is ready to begin receiving media in the form of an RTP stream, a logical connection is opened between the far end and the call control entity. The call control entity determines a suitable RTP port on which the media entity is to receive the RTP stream. Via the protocol described herein, the call control entity directs the far end to establish a media channel between the far end and the media entity. When the media channel is established, the logical connection is acknowledged and the far end transmits RTP stream to the media entity. To transmit media data, the call control entity allocates a media entity port for transmission and opens a logical connection with the far end. The call control entity directs the media entity to transmit a RTP stream to the far end via the allocated transmission port. The media entity communicates to the call control entity that it is transmitting the media stream.

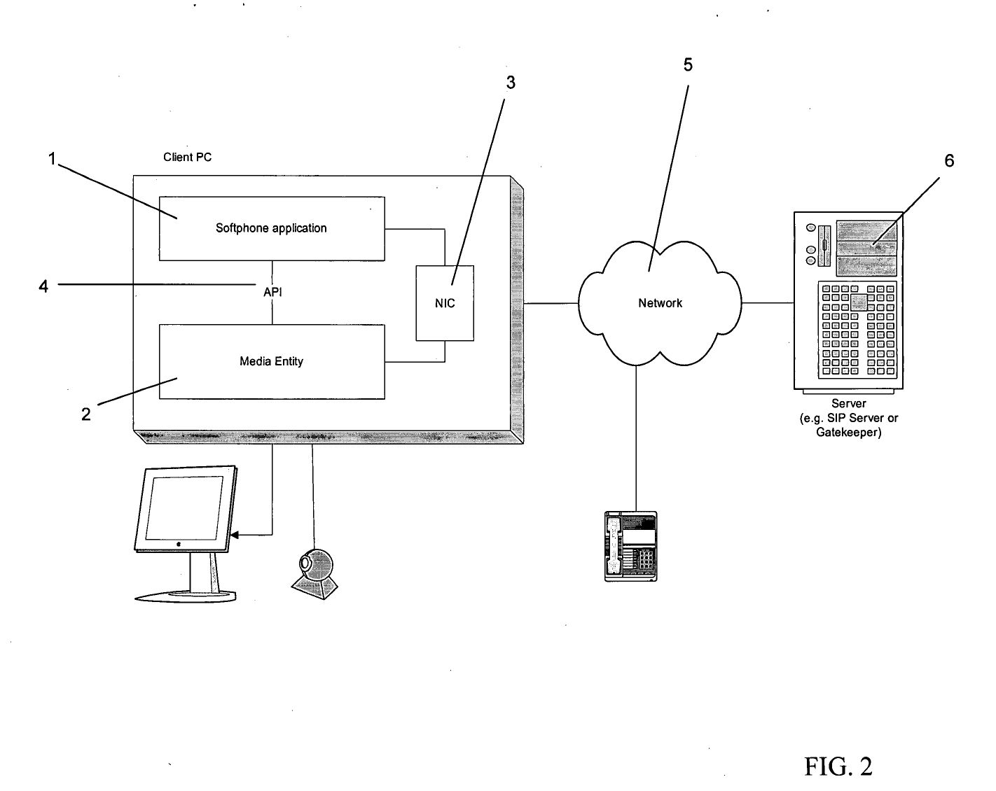

FIG. 2 depicts a conferencing system embodying aspects of the features taught herein. The call control entity is a softphone application 1 and the media entity is a video conferencing application 2. Both applications are running on a single PC, which is connected to a network 5 via network interface card 3. With such a system, a user using softphone 1 to communicate with a far end that is connected via server 6 may decide to implement the expanded media capabilities of the present teachings, for example, to have a video conference. Initialization begins when the call control application 1 calls an API 4, causing an executable to be loaded and an interface pointer to be passed out of process to the call control application. The call control application uses a media-manager application to initialize the system, discover channels, streams, properties, etc. API 4 provides an interface to control a video window on the user's PC. Configuring the system is done by setting properties and by using the manager application to do things like select the active camera, etc. The API 4 provides a user interface to control the placement of the preview window, discover far end channel/video capabilities, register events (such as incoming video), position the remote video window, etc. API 4 queries for the media capabilities of the far end and directs the far end to establish a media channel with the video conferencing application 2. An RTF media stream can be transferred between the far end and the videoconferencing application 2. The API 4 also provides an interface to setup, modify and stop the RTP media stream. Actions taken on these interfaces result in media flows beginning that trigger notifications to the call control application 1 that video is coming in or going out. Call control application continues to process the call control stream, which is typically SIP, H.323, etc. The media entity 2 and the call control entity 1 communicate, for example, over an ActiveX interface.

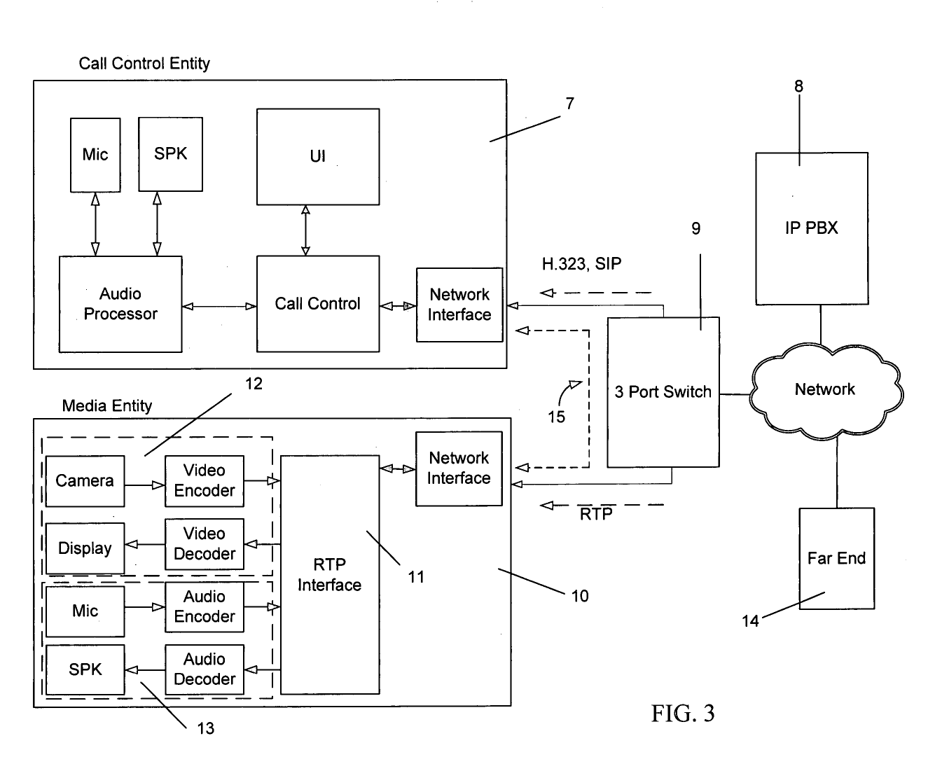

FIG. 3 illustrates an alternative system wherein the call control device is an IP phone 7 connected to an IP PBX box 8 via a three port switch 9. The media entity 10 includes an RTP interface 11 connected with equipment for processing video 12 and audio media 13. The media entity is also connected to the three port switch 9. Both the IP phone and the media entity are equipped, for example with firmware, so that they can communicate with each other via the protocol described herein. When a user desires to establish a media call, he uses the call IP phone 7 to connect with a far end. The IP phone 7, the media entity 10 and the far end exchange capabilities and establish call control channels and media channels, as described in FIG. 1. According to the embodiment illustrated in FIG. 3, the call control channel will be established between the IP phone 7 and the far end and the media channel will be established between media entity 10 and the far end.

The protocol can be based on XML Schema. This provides the ability to extend Schema without affecting existing implementations. Using XML for describing messages, commands, responses, properties, configuration information, and logging information allows for use of standard web technology like XSLT and XCAP for controlling a media device. XML allows platform developers to reuse already existing XML parsing libraries or use special-built XML parsers for a particular service. Also, XML schemas allow platform developers the ability to choose validating parsers, which guard against syntax vulnerabilities that exist in other text-based network protocols.

Media entities require reasonable security to prevent attacks on them, for example, in the form of media eavesdropping, barge-in, device hijack for DDos attacks, unauthorized use, and playback attacks. In the case of a secure media, the devices must be able to securely pass back and forth the stream keys between the call control entity and the media entities. Some form of authentication for binding between media entity devices is preferably used. A variety of security authentication schemes known to those of skill in the art are supported, for example: One-Time-Password Mechanism (RFC 2444); Plaintext user/password (RFC 2595); and anonymous binding (RFC 2245).

Logical services are associated with various media entities. For example, a media entity might provide a service for transmitting live video, such as a video conference feed, and a service for transmitting content video such, such as a recorded video presentation. Most media entity services support media streams in some form, for example they can: create transmit channel and receive streams independently (logical independence); create transmit and receive streams in any order (temporal independence); create transmit and receive streams “simultaneously”, etc. These services are addressed within particular messages within the protocol. The services are defined using XML Schemas.

Associations describe the mapping between the control entities and media entities. Associations have two dimensions. The first dimension reflects the control point to media entity mapping, for example: one call control device to one media device; one call control device to many media devices; or many call control devices to many media devices. The second dimension of association is duration. There are two types of duration; promiscuous and monogamous. A typical example of a promiscuous association is a content encoder in a conference room. In this mode, various users would connect their content source to the encoder for a short period of time and then leave. An example of monogamous association would be a desktop phone controlling a video media entity on the same desktop. The difference between these two associations requires that the association and authentication models be relatively lightweight. Associations have time durations from a single session to infinite.

Standard network device management such as SNMP is typically too heavy for some lightweight media entities according to some embodiments of the invention. It is desirable that some device management be present. It is unlikely that a modem enterprise network manager would allow networked devices onto their network in this day of worms, Trojan horses and viruses without being able identify and manage such devices from a central location. This requirement is extended for ISP and IP Centrex-like environments where these devices are actually owned by third parties. The approach, according to the present invention, is to view the provisioning and management information present on the device as a single unified XML document. This “document” is reflected in an XML schema that describes the tree. The XML syntax for modifying this “document” is described in XCAP (XML Configuration Access Protocol). XCAP allows a client to read, write and modify device and service configuration data, represented in XML format on the media device.

The protocol of the present invention provides two logging services: a LogServer service that might be a front end to a WINDOWS® event log or syslog, and a LogClient service that produces logging information. The LogServer Service allows formatted messages to be sent to it. The service synchronizes messages from various sources into a single log. This single point is then exposed to allow LogClients to read the synchronized logs. The LogServer service supports an interface that looks similar to Log4J that allows various log clients to read logs separated by service as well as message severity.

The transport layer is responsible for the actual transmission of requests and responses over network transports. This includes determination of the connection to use for a request or response in the case of connection-oriented transports. The transport allows devices to communicate using reliable connection-oriented (ex: TCP, SCTP) transport protocols. When entities use a connection-oriented protocol (such as TCP or SCTP) to send a request, they typically originate their connections from an ephemeral port. The transport allows easy transversal of firewalls and gateways and allows reuse and sharing of the connection mechanism. According to some embodiments, the connection sharing mechanism allows entities to reuse existing connections for requests and responses originated from either peer in the connection; allows entities to reuse existing connections with closely coupled nodes that act as a single system entity; and prevents unauthorized hijacking of other connections.

In using a connection-oriented transport such as TCP or SCTP, individual messages must be framed within the packet stream. The framing information should allow the lowest level host application code to weakly validate the message. A message frame must contain: an easily identifiable (and unique) starting character sequence; the service that the message is bound for; a non-monatomic increasing message number that uniquely identifies this message across all services; a non-monatomic increasing sequence number that uniquely identifies this message within the particular service; a continuation identifier if the message runs across physical packet boundaries; a payload size that specifies the exact number of octets in the payload; an easily identifiable ending character sequence; the sender; TTL for the message; and version.

A system and method has been shown in the above embodiments for the effective implementation of media devices over IP. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware or specific multimedia transmission protocols. Existing and future input/output devices are envisioned within the scope of the present invention.

1. A method of establishing a media call, wherein a data stream comprises a call control channel and one or more media channels, the method comprising:
establishing a network connection with a far end device, wherein the connection comprises a the call control channel;
establishing a network connection with one or more media entities;
directing the far end device to establish a media channel between the far end device and the one or more media entities;
directing the one or more media entities to process the media channel.

2. The method of claim 1, wherein the connection with the one or more media entities utilizes a XML based protocol.

3. The method of claim 1, wherein the one or more media entities is a software application, an integrated DSP/display, or a video conferencing CODEC.

4. The method of claim 1, wherein the call control channel utilizes a protocol selected from H.323, and SIP.

5. The method of claim 1, wherein the media channel between the far end device and the one or more media entities utilizes RTP.

6. The method of claim 1, wherein the media channel comprises live video.

7. The method of claim 1, wherein the media channel comprises audio media.

8. The method of claim 1, wherein the media channel comprises content video.

9. A system for establishing a media call, comprising:
a call control entity that is capable of establishing a network connection with a far end device, wherein the connection comprises a call control channel;
one or more media entities configured to establish a connection with the call control entity and configured to receive a media channel from the far end.

10. The system of claim 9, wherein the connection between the call control entity and the one or more media entities utilizes a XML based protocol.

11. The system of claim 9, wherein the media entity is a software application, an integrated DSP/display, or a video conferencing CODEC.

12. The system of claim 9, wherein the call control entity is an IP telephone, soft phone, or a PDA.

13. The system of claim 9, wherein the call control channel utilizes a protocol selected from H.323, and SIP.

14. The system of claim 9, wherein the media channel between the far end device and the one or more media entities utilizes RTP.
